(19) United States
(12) Patent Application Publication
(10) Pub. No.: US 2012/0179414 A1
(43) Pub. Date: Jul. 12, 2012

(54) REMOTE MEASURING SYSTEM AND METHOD FOR TESTING A REMOTELY PLACED OBJECT

(75) Inventors: Holger SPECKMANN, Schwanewede (DE); Clemens WESTERKAMP, Osnabrueck (DE)

(73) Assignee: AIRBUS OPERATIONS GMBH, Hamburg (DE)

(21) Appl. No.: 13/404,284

(22) Filed: Feb. 24, 2012

Related U.S. Application Data
(63) Continuation of application No. PCT/EP2010/062382, filed on Aug. 25, 2010.
(60) Provisional application No. 61/237,778, filed on Aug. 28, 2009.

(30) Foreign Application Priority Data
Aug. 28, 2009 (DE) 10 2009 039 256.4

(51) Int. Cl. G06F 19/00

(52) U.S. Cl. 702/122

(57) ABSTRACT

A remote measuring system includes a test apparatus connected to a sensor for testing an object, a communication unit, and a remoteoperating unit. Control signals may be sent from this operating unit to the communication unit to operate the test apparatus. A data processing unit performs a compression process of a first flow of test data emanating from the test apparatus and sends a second flow of test data to the operating unit. The data processing unit performs a quantisation process, which may be controlled through control signals at the operating unit. A remotely located expert may thus receive a direct and qualified impression of the procedure and the inspection results and give advice on correct procedures or on changing the manner of the recording. By obtaining support from experts, time is saved and the transfer of know-how and the use of experts is improved.

### CROSS-REFERENCE TO RELATED APPLICATIONS

This is a continuation of International Application No. PCT/EP 2010/062382, filed Aug. 25, 2010, which claims priority to U.S. Provisional Application No. 61/237,778, filed Aug. 28, 2009 and to German Patent Application No. 10 2009 039 256.4, filed Aug. 28, 2009, the disclosures of which are all hereby incorporated in their entirety by reference.

### TECHNICAL FIELD

The technical field relates to a remote measuring system, a method for conducting a test method on a remotely placed object, and the use of such a remote testing system.

### BACKGROUND

In the regular maintenance of large vehicles, for example aircraft and ships, complex test apparatus are often used in order to test structural integrity. Such complex apparatus may comprise ultrasound and X-ray systems for examining materials, which may provide the user with graphic information as well as test data. The operation of complex test apparatus with a very wide range of sensors and the interpretation of results requires many years of experience, even once the appropriate manufacturer's training has been given. In the case of special examinations, it is therefore necessary to request the support of specialised experts. However, in cases where such large vehicles are scattered around the world, it is not always possible to find such experts easily on demand, which means that cooperation through different communication media is necessary, or alternatively, the expert will be required to travel to the vehicle. The latter option is costly, both in terms of time and cost, and is thus not regarded as being an ideal solution. The use of communication means enabling people “on the spot” (e.g., where the vehicle is located or on board the vehicle) to be questioned and instructed is increasingly regarded as a practical solution. Moreover, when it comes to the maintenance of aircraft, examinations sometimes require an interaction between test apparatus and an expert and this makes communication in this respect more difficult.

Nowadays, consultations with experts may be carried out quite simply by telephone and by fax for the purpose of tracking down a problem. However, it is not always straightforward to outline the problem, so that frequent use has to be made of e-mails with attachments containing test results in the form of illustrations or reports. A possible alternative could be the use of a video-supported collaboration with conventional video-conferencing systems. However, these systems are typically used in a stationary manner in conference rooms or on office desks. These video-conferencing systems frequently contain computerised systems enabling a number of participants at different locations to cooperate in a particular application (known as “Application Sharing”). This type of use usually takes place in a stationary environment, which means that the incorporation of external test apparatus in a test hall on site on an aircraft is not always possible.

Mobile Teleservice Systems are also known, but these do not have the capability of incorporating an external test apparatus in addition to conventional video and audio data transmission systems, and of controlling test apparatus.

Furthermore, there are also items of test apparatus, with which, on the basis of data files, an asynchronous data exchange may be carried out, so that configuration data or test reports may be prepared for local evaluation at one site, and thereafter sent to another site.

In addition, all of the above possibilities may be implemented in such a way that a very generous band width is available for the transmission of graphic and audio information, so that, in the case of data connections with a low data band width in particular, the use of Teleservice or conferencing systems is not practical for the purpose of consulting remote experts, transmitting instructions, and checking test data in real time. In addition, other demands, desirable features and characteristics will become apparent from the subsequent summary and detailed description, and the appended claims, taken in conjunction with the accompanying drawings and this background.

### SUMMARY

The present disclosure proposes a remote measuring system, with which an expert, with complex test apparatus, may examine a remote object and practically in real time receive test data which could also include graphic data.

One embodiment of the present disclosure provides the ability to carry out an examination using the test system, even though only relatively slow data connections to the expert might be possible.

A further embodiment provides the ability to arrange for the test apparatus to be controlled by the expert without the latter having to be on the spot using a remote measuring system in accordance with the present disclosure.

In accordance with a first embodiment, the remote measuring system includes at least one test apparatus, at least one communication unit, and at least one operating unit. The test apparatus and the communication unit are coupled together, so that the communication unit is able to receive a first flow of test data from the test apparatus. Moreover, the operating unit is coupled with the communication unit and set up in such a way that it may send control signals to the communication unit so as to operate the test apparatus and receive a second flow of test data from the communication unit. In this case, the operating unit is not located at the same site as the communication unit but is connected via a random data connection system with the communication unit and enables an expert present at the operating unit to be included in the remote measuring system.

The communication unit includes a data processing unit, through which the first data flow may be compressed and the resulting compressed second data flow may be sent to the operating unit. The data processing unit is set up in such a way that it may adapt the second flow of test data to an available data transmission bandwidth, which could be low in comparison, between the communication unit and the operating unit and carry out a quantisation, wherein the quantisation may be controlled by the control signals at the operating unit. In principle, the quantisation signifies the conversion of data within the framework of defined graduations, which could possibly be given in bits.

At the same time, the first flow of test data may contain test values in the form of figures from sensors, video data from a sensor, a camera or another optical recording device, audio data or data from the screen of the test apparatus for the information of the expert located at the operating unit.

One important effect lies in the fact that, for example, video data from the test apparatus may be compressed and quantised, so that they could also be transmitted to the operating unit via slower data connections. However, since distortions may arise during compression and in particular during quantisation, it is particularly sensible for the quantisation to be controlled by the user, i.e. in this case, an expert located remote from the object in question. Subjectively, the effects of these distortions are perceived differently, but if the quantisation may be implemented in a different manner and controlled by experts, the subjectively perceived distortions may be minimised. The method of implementation could be distinguished on the basis of the following criteria:
a) The dynamics of the test result are of paramount importance. For example, a sensor, such as an ultrasound sensor, of the test apparatus has to be applied to the surface of a vehicle. Here it is essential that the position, the angle and the alignment of the sensor are all correctly set. In this respect, the ideal situation is a quantisation that provides a rapid refresh rate of the image and only a small amount of delay.
b) The precision of the test result is of paramount importance. For example, a sensor may be accurately read if it is correctly aligned. In this respect, it is acceptable for the refresh rate to be low and accordingly the delay large.

In other words, a first flow of test data with graphic data, for example, ultrasound or X-ray images and test data in numerical form, may be sent by using the remote measuring system in accordance with the present disclosure via a slow data connection as a second flow of test data to a remotely located expert, with this expert being able to control this transmission and the quality thereof independently.

In this connection, it is also conceivable that in the case of any particularly pronounced changes of test data in the form of figures and graphic data, the data processing unit will carry out an automatic adjustment of the quantisation, wherein the expert will be able to intervene manually in this automated quantisation process.

in a further embodiment, the data processing unit may be set up in such a way that it does not fully compress graphic information with a high resolution and send this to the operating unit, but where necessary, and controlled by the expert, primarily considers individual image sections (“regions of interest”) and sends these to the operating unit after appropriate compression and quantisation. Preferably, the regularly updated image section will be provided with a corresponding reference mark or, alternatively, the other sections may be shaded.

In a further embodiment of the remote measuring system in accordance with the present disclosure, the test apparatus includes a screen configured to display test data and graphic data, wherein the test apparatus is set up in such a manner that the contents of the screen may be sent as a first flow of test data from the test apparatus to the communication unit. The advantage of this is that, for example, the so-called Remote Frame Buffer Protocol (RFP) may be used for transmission, in which only image differences from a basic image are sent. The screen contents may constitute the first flow of test data received from the test apparatus, which may then be further compressed in order to reduce the required connection speed to the operating unit.

In yet a further embodiment of the remote measuring system in accordance with the present disclosure, the communication unit and the operating unit are connected by an ISDN line, thereby ensuring autonomy from a local data network and even the coding is relatively simple. A connection may be made quickly beyond organisational limits without any costly adjustment of internal company network appliances being required. Through the selected manner of the dynamic adjustment of quantisation, it is also possible to work with other communication channels with a low data rate, for example, through mobile radio systems.

In a further embodiment of the remote measuring system in accordance with the present disclosure, the data processing unit is set up in such a way that a Discrete Cosine Transformation (DCT) of the first flow of test data may be carried out and graphic data from the first flow of test data may be compressed using an image compression process. By using the Discrete Cosine Transformation, a time-discrete signal is transformed from the local to the frequency range, so that graphic data may be brought into a form that may be efficiently compressed. By applying a standard process for the compressing of graphic data, different compression processes may be used, wherein, depending on the experience with the remote measuring system in accordance with the present disclosure, different compression processes may be tested and exchanged in order to improve the efficiency of the remote measuring system even further.

In another embodiment of the remote measuring system in accordance with the present disclosure, in addition to the second flow of test data, a bi-directional communication connection may be generated between the operating unit and the communication unit. Thus, a communication data flow may be sent from the operating unit to the communication unit, with the result that an operator on the spot with the object to be tested may receive instructions from the expert at the operating unit and consequently, for example, move, replace or adjust the test sensor. The flow of communication data may be of any type and may include, for example, audio data, video data, or text information. As indicated, the flow of communication data is preferred for a bi-directional transmission, so that it is possible not only for the expert at the operating unit to instruct an operator of the test apparatus verbally, in the form of text data or in a form of video telephony, but also for the expert to show, by means of a camera image from the communication unit, where a particular sensor at any given moment may be found on the object under examination, while at the same time the recorded test data and a screen content from the test apparatus are being prepared by the second flow of test data at the operating unit. In this way, it could be imagined that, with the transmission of a video image, the expert could give the operator an instruction as to what should be done to the test apparatus or the sensor. If video data are to be transmitted from the operating unit to the communication unit, it is conceivable that, as a result of controls inputted by the expert and/or given a momentarily larger second flow of test data, the operating unit could be set up in such a manner that the required data band width is reduced for the video transmission. This could also be achieved in this case by reducing the refresh rate, i.e., of the number of images to be transmitted in each unit of time or also by reducing the quality of the image.

Consequently, the remote measuring system in accordance with the present disclosure is capable of transmitting test data in numerical form and also the contents of a screen to an expert located at the operating unit, while at the same time a bi-directional flow of communication data passes between the operating unit and the communication unit. At a comparably low data bandwidth, such as with the use of an ISDN line, the communication unit of the remote measuring system in accordance with the present disclosure may advantageously prepare and mix these data flows that are required to be transmitted, so that at any time sufficient information is available both at the communication unit and at the operating unit.

A process for the implementation of a test of a remote object is also provided which includes using the remote measuring system in accordance with the present disclosure to examine an aircraft.

### BRIEF DESCRIPTION OF THE DRAWINGS

Further features, advantages and possible applications of the present disclosure will become apparent from the following description of the embodiments and from the drawings,wherein the same references numerals are used for identical as for similar objects.

FIG. 1 shows a schematic overview of the remote measuring system in accordance with an embodiment of the present disclosure;

FIGS. 2a to 2c show a typical view of the contents of a screen that are to be transmitted; and

FIG. 3 shows a schematic block diagram of a process in accordance with the present disclosure.

### DETAILED DESCRIPTION

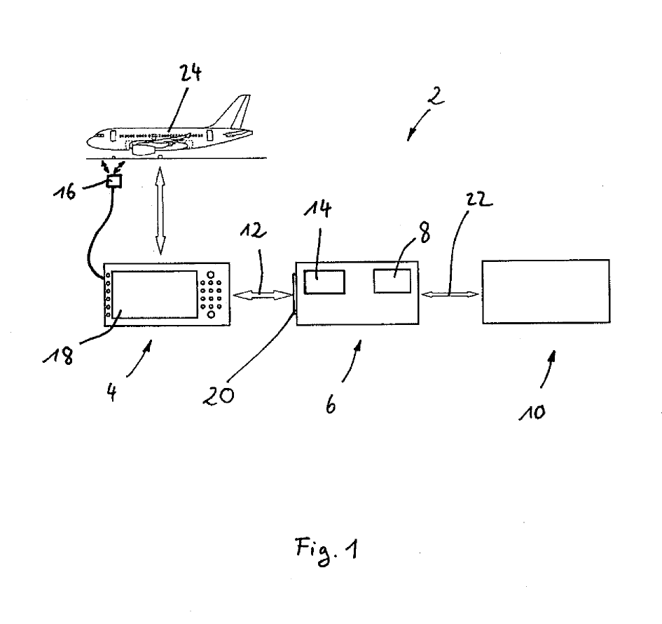

FIG. 1 shows a remote measuring system 2 including at least one test apparatus 4, one communication unit 6 with a data processing unit 8, and one operating unit 10. The communication unit 6 is connected to the test apparatus 4 by means of a data connection 12 which, for example, may be in the form of a conventional form of connection, such as Ethernet, Fire Wire, USB or the like. The test apparatus 4 is thus able to send a continuous first flow of test data to the communication unit 6. This first flow of test data could include graphic data and numerical test values, wherein the graphic data may also contain test data in the form of blended displays.

The actual configuration of the test apparatus 4 is very flexible; practically all types of test apparatus available on the open market may be used in the system 2 in accordance with the present disclosure, provided that they are capable of generating a first flow of test data. This flow of test data need not necessarily be in digital form, it could also be in analogue form, in which case the communication unit 6 could comprise a corresponding digitizing unit 14. In the simplest case, the test apparatus 4 could be in the form of a computer unit on which a specialised test application has been installed and which is operated in conjunction with externally connected sensors 16. The test apparatus 4 includes typically a screen 18, on which test results, ultrasound images, x-ray images and the like are displayed. Optionally, the test apparatus could also be configured in such a way that data may be made ready for a screen and prepared on a video-adapter for the direct connection of an external monitor or via a standardised protocol to generate a screen presentation in the form of an X window environment. All types of screen presentations may accordingly be transmitted through the first data connection 12 and a corresponding interface 20 to the communication unit 6, where the represented screen contents are further processed. To increase the flexibility of the system in accordance with the present disclosure, the evaluation unit 6 may include a number of different standardised interfaces 20, so that even a test apparatus 4 from different manufacturers may easily be connected to the communication unit 6.

Alternatively, the test apparatus 4 may also prepare numerous test values and digital or analogue video data, wherein the latter is accordingly digitized by a digitizing unit 14 and produced as a first flow of test data. Any digital numerical test values could be integrated into the first flow of test data with the aid of a multiplexer or other installations or treated separately as an additional flow of test data, which is transferred from video or graphic data.

In the following example, it is assumed that the first flow of test data represents a screen content of the test apparatus 4 and is transmitted via the Remote Frame Buffer Protocol (RFP). This first data flow with the graphic data and/or test data of the test apparatus 4 is compressed in the data processing unit 8 of the communication unit 6 for long distance traffic transmission. The data processing unit could compress the image received from the test apparatus 4 using a standard coding system or a system especially adapted for the remote measuring system 2, wherein a discreet cosine transformation would be carried out to prepare the graphic images followed by a quantisation.

The data prepared in this manner are transmitted as a second flow of test data through a data connection 22 to the operating unit 10, wherein the operating unit 10 could also be located at a very remote position. The connection speed of the second data connection 22 could be correspondingly low. For a rapid and uncomplicated operation of the remote measuring system in accordance with the present disclosure, for example, within a different company, the second data connection 22 could be made using an ISDN line, as the necessary initial technical work and the bureaucratic and administrative preliminaries and the like that are involved in a company network are avoided and ISDN lines may be quickly implemented. However, where there are regular or prolonged connections between two fixed locations for the communication unit and the operating unit, the use of an IP based transmission system could be recommended.

The operating unit 10 is configured in such a way that it may send control signals through the second data connection 22 to the communication unit 6, so that, for example, even the quantisation process may be controlled by the data processing unit 8 by these control signals. If, for example, it is necessary for the sensor 16, which is typically used as an ultrasonic sensor, to be moved across the outer surface of the object 24 being tested and to observe changes in the test data during this process, it is advantageous if a correspondingly high refresh rate of the test data could be achieved. In such cases, the refresh rate could be chosen to be high, while keeping the resulting image quality very low. If the global test data changes are observed and, for example, a final test location for the sensor 16 is found, the quantisation process could be adapted in such a manner that the refresh rate of the second flow of test data could be reduced while the quality of the transmitted images could be improved.

Although the object 24 illustrated in FIG. 1 is an aircraft, this is only intended as an example and it could represent any kind of large object, which would be too expensive to transport to a remote expert.

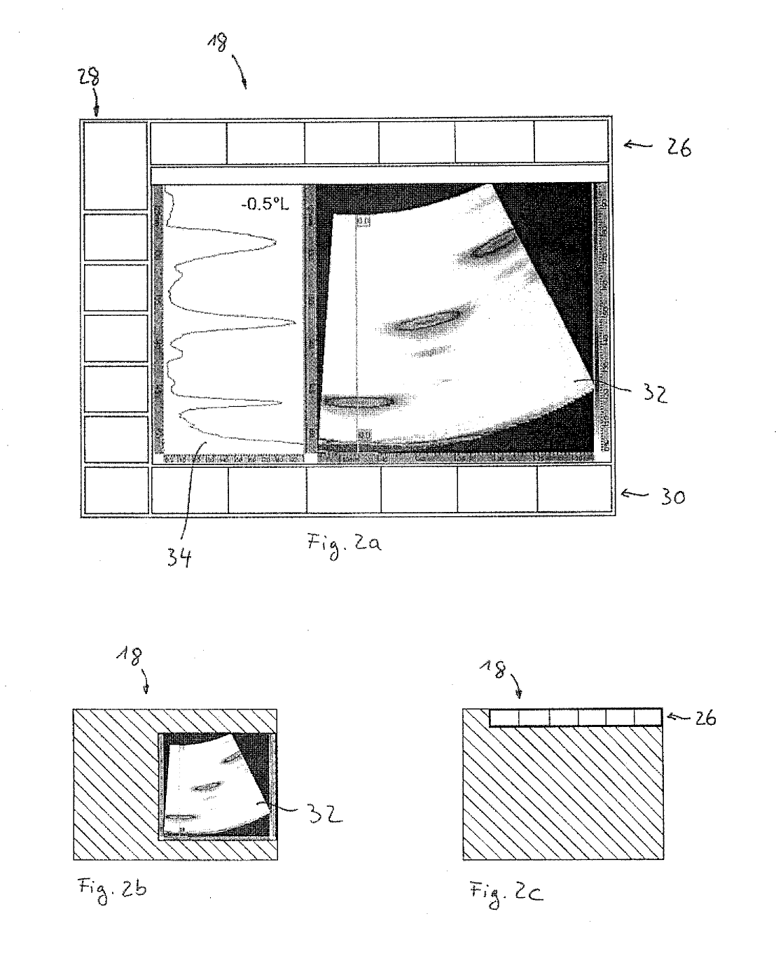

FIG. 2a shows by way of example the contents of a screen 18 of the test apparatus 4, which is subdivided for example into four areas. Status reports could be blended into the top edge 26, while on the side 28 and at the bottom edge 30, operating elements may be shown, which, depending on the actual application, may fulfil varying functions. A video presentation may be shown on the largest part of the screen 18, typically depicting ultrasonic or x-ray images 32 and the respective test diagrams 34. These illustrations are intended only as examples and may therefore be replaced by other types of illustrations.

If the screen contents of a test apparatus 4 are transmitted by the remote measuring system 2 in accordance with the present disclosure, it could prove to be advantageous if individual areas of the screen could be filtered out in the communication unit 6, so that the resulting refresh rate may be increased. This could be shown for example in the status reports in the top side 26 as shown in FIG. 2c or by the simple display of ultrasonic images 32, which for example could be relevant when re-positioning or adjusting the test apparatus 4, as shown in FIG. 2b. To a person skilled in this particular art it is clear that these illustrations are only intended to be examples and that other areas of a randomly arranged screen as well may be filtered out and transmitted on their own.

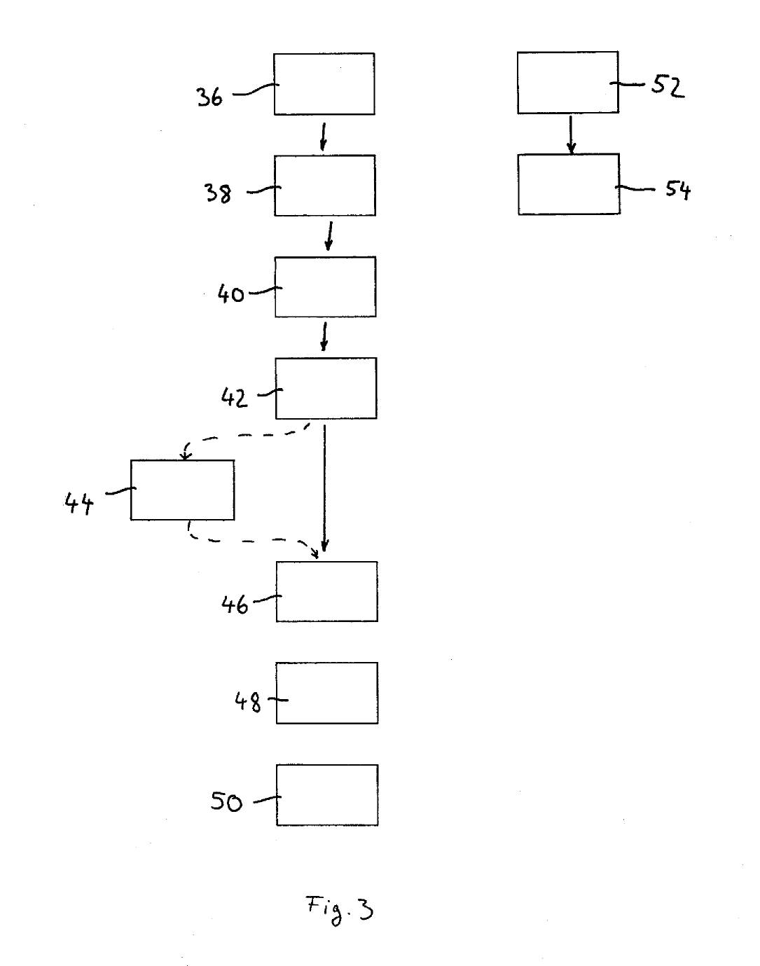

Finally, FIG. 3 shows a schematic block diagram of a process in accordance with the present disclosure including the following steps. The operating unit 10 could send 36 control signals to the communication unit 6, from where the relevant parts, namely, the control signals relating to the test apparatus 4, are sent 38 to the test apparatus 4. If a part of the control signals represents a requirement for the setting of the control apparatus 4 to be changed, the test apparatus 4 can make this change 40. Control signals that are used to change the quantisation settings or the like may remain in the communication unit 6.

In general, the test apparatus 4 sends 42 the first flow of test data to the communication unit 6. Depending on the nature of the data in the first flow of test data, an initial digitizing 44 may be necessary. If the test apparatus 4 is in the form of an independent computer unit, which is equipped with a screen or systems for generating images, this digitizing may not be necessary. The first flow of test data could be processed 46 in a subsequent step with the discreet cosine transformation followed by quantisation 48, which may be controlled by the control signals from the operating unit 10. Finally, the resulting compressed second flow of test data is sent 50 to the operating unit 10.

Parallel to this and regardless of the other steps in the process, it would be advantageous if the bi-directional transmission 52 of additional communication data could be made possible between the operating unit and the communication unit, wherein the communication data received previously could be reproduced 54. The communication data could be, for example, information transmitted by speech, by text or by video data requesting a person to help at the site, adjustments to be made to the test apparatus 4 or the re-positioning of one or more sensors 16 or the like.

An expert who is remote from the object to be tested receives an immediate and qualified impression of the progress and the results of an inspection or an examination. He may, for example, give advice on correct procedures or on changing the manner or the place for recording data. Because of the possibility of the frequently changing locations of the communication unit and the use of the ISDN operating unit, a connection is available with defined service quality features. If required, the high level of security that is inherent in the use of ISDN may be increased further by the use of a coding. The participating apparatus of the remote measuring system 2 in accordance with the present disclosure may operate without the constraints of a local electronic data processing and an outside infrastructure, which favours rapid and flexible use, even in the case of a short term change of location. In this way, in this case the remote measuring system 2 in accordance with the present disclosure could be superior to all IP based solutions, even if the data rate is limited. Because of the possibility of observing test results and live images at the operating unit 10 in parallel, a hitherto impossible, virtually realistic impression is obtained. Through the greatly accelerated means of obtaining support from experts in carrying out complex tests, time is saved and the transfer of know-how and the use of experienced experts is significantly improved.

Finally, it is to be noted that the term “comprising” is not intended to preclude other elements or steps and that “a/an” does not preclude a plural form. It is also noted that features or steps, described by means of references to one of the above embodiments, may also be used in combination with other features or steps of other embodiments described above. Reference marks contained in the claims are not to be seen as being a limitation. Moreover, while at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A remote measuring system, comprising
At least one test apparatus connected to at least one sensor;
At least one communication unit; and
At least one operating unit;
wherein the operating unit is adapted such that it may send control signals for the operation of the test apparatus to the communication unit;
wherein the communication unit is adapted such that it may receive a first flow of test data from the test apparatus by compressing the first flow of test data of a data processing unit and send a second flow of test data to the operating unit; and
wherein the data processing unit is adapted such that it may quantise the second flow of test data and adapt to the available data transmission band width between the communication unit and the operating unit, wherein the quantisation may be controlled by control signals at the operating unit.

2. The remote measuring system in accordance with claim 1, wherein the first flow of test data contains graphic data.

3. The remote measuring system in accordance with claim 2, wherein the graphic data comprise illustrations of test results and status data of the test appliance.

4. The remote measuring system in accordance with claim 3, wherein the test apparatus is adapted such that it may generate graphic data for a screen for the presentation of test results and the first flow of test data represents the contents of the screen of the test apparatus.

5. The remote measuring system in accordance with claim 4, wherein the first flow of test data and the second flow of test data comprise graphic data on a Remote Framebuffer Protocol basis.

6. The remote measuring system in accordance with claim 5, wherein the data processing unit is adapted such that, in response to control signals from the operating unit, only a part of the image represented by the graphic data is processed and the remaining part of the image is filtered out.

7. The remote measuring system in accordance with claim 6, wherein the data processing unit is adapted such that, in the quantisation process it reduces the refresh rate or the sharpness of the details of the second flow of test data.

8. The remote measuring system in accordance with claim 7, wherein the data processing unit is adapted such that it may reduce the refresh rate or the sharpness of the details of the second flow of test data when so instructed by the control signals from the operating unit.

9. The remote measuring system in accordance with claim 8, wherein the communication unit and the operating unit are coupled together by means of an ISDN line.

10. The remote measuring system in accordance with claim 9, wherein the communication unit and the operating unit are adapted such that they send a flow of communication data from the operating unit to the communication unit and reproduce this at the communication unit.

11. A method for conducting a test process on a remote object, comprising the following steps:
Sending control signals to operate a test apparatus from an operating unit to a communication unit connected to the said test apparatus;
Sending a first flow of test data to the communication unit;
Carrying out a quantisation of the first flow of test data in a data processing unit in the communication unit so as to receive a second flow of test data; and
Sending the second flow of test data from the communication unit to the operating unit.

12. The method in accordance with claim 11, further comprising:
Sending control signals from the communication unit to the test apparatus for the adjustment of the test apparatus.

13. The method in accordance with claim 12, further comprising:
Bi-directionally transmitting communication data between the operating unit and the communication unit; and
Reproducing the communication data.

14. The method in accordance with claim 13, further comprising:
Digitizing the first flow of test data.

15. The remote measuring system in accordance with claim 1, wherein the sensor is associated with testing an aircraft.
